(19) United States
(12) Patent Application Publication
(10) Pub. No.: US 2014/0130328 A1
(43) Pub. Date: May 15, 2014

(54) VARIOUS ARTICLE ADHESIVE HOLDER

(71) Applicant: Christopher Espiritu Africa, La Habra, CA (US)

(72) Inventor: Christopher Espiritu Africa, La Habra, CA (US)

(73) Assignee: Africa Espiritu Christopher, La Habra, CA (US)

(21) Appl. No.: 14/024,626

(22) Filed: Sep. 12, 2013

Related U.S. Application Data
(60) Provisional application No. 61/699,295, filed on Sep. 11, 2012.

(51) Int. Cl. F16M 13/02

(52) U.S. Cl. CPC F16M 13/02
USPC 29/428; 248/205.3

(57) ABSTRACT

An improvement to a various article holder having a slender rigid main body section, securing fastener which communicates with mounds. The fasteners are made of rigid elastic material so it can secure a variety of articles and can be moved along said mounds to accommodate different sizes of articles. The solid body are made of a rigid and durable material such stainless steel and conducive of designs or graphics. The opposite side of the mounds have adhesives in order to be properly stored on a multitude of flat surfaces.

### CROSS-REFERENCE TO RELATED APPLICATION

This application claims the benefit of provisional patent application Ser. No. 61/699,295 filed 2012 Sep. 11 by the present inventor.

### RELATED ART

The following is a tabulation of some prior art that presently appears relevant:

| | Date: | Name: | Classification: |
|---|---|---|---|
| Pat. No.: | | | |
| U.S. D573652 | Jul. 22, 2008 | Esfahani, Amir | D19/81 |
| U.S. D620,981 A | Aug. 3, 2010 | Sturken, Axel | D3/206 |
| U.S. Pat. No. 3,627,182 | December 1971 | Calkins, Forrest I. | 224/584 |
| U.S. Pat. No. 5,880,713 | March 1999 | Belardinelli, | 211/Alexander M. 69.1 |
| US-2003/0059570 | January 2002 | Touzani, William | 428/99 |
| U.S. Pat. No. 3,800,974 | April 1974 | Mogel et al. | 211/69.1 |
| US-2002/0027357 | March 2003 | Lake, Gary F. | 281/30 |
| U.S. Pat. No. 5,820,095 | October 1998 | Stone, John W. | 211/69.1 |
| U.S. Pat. No. 5,664,673 | September 1997 | Perry, Irvin Gene | 206/371 |
| U.S. Pat. No. 5,000,327 | March 1991 | Kincheloe, Allen 2 | 06/232 C. |
| U.S. Pat. No. D545, 675S | Jul. 3, 2007 | Liebers, Steven B. | D9/434 |
| US-2002/0096439 A1 | Jul. 25, 2002 | Lin, Linus | A43C 11/04 |
| US 2004/0200040 A1 | Oct. 14, 2004 | Frassanito, Rodolphe | A45 F 5/06, 23/3.3 |
| US-2005/0279648 A1 | Dec. 22, 2005 | Liebers, Steven B. | A45C 11/04, 206/5; |
| | | | 248/693 |
| US-2007/0215493 A1 | Sep. 20, 2007 | Servis, Alice M. | 206/5 |
| U.S. Pat. No. 3,136,409 | Jun. 9, 1964 | Schumann, Lawrence R. | |
| U.S. Pat. No. 4,820,071 | Apr. 11, 1989 | Steinfield, Robert J.; Sterling | 402/4; |
| | | | 402/80 R; 281/30 |
| U.S. Pat. No. 5,066,152 | Nov. 19, 1991 | Renaud, Maurice J. | 401/131; 23/11 HC; |
| | | | 23/10 R; 23/3 R |
| U.S. Pat. No. 5,298,089 | Mar. 12, 1996 | Motyka, Kenneth J. | 402/3; |
| | | | 281/30; 402/79 |
| U.S. Pat. No. 5,718,023 | Feb. 17, 1998 | Billish, Thomas P. | 23/11 HC; |
| | | | 233/9; 23336; 224219; 224674; 224251 |
| U.S. Pat. No. 5,881,434 | Mar. 16, 1999 | Rigney, Douglas E. | 24/11 R; 24/67/9; |
| | | | 24/531; 24/563; 248447/2 |
| U.S. Pat. No. 5,983,459 | Nov. 16, 1999 | Goldberg, David | 24/3.3; 24/326; 24/336 |
| U.S. Pat. No. 6,113,297 | Sep. 5, 2005 | Kovaclk Peter, Thomas | 402/4; 281/28; |
| | | | 281/37; 3-2/79 |
| U.S. Pat. No. 6,382, 569 B1 | May 7, 2002 | Schattner Robert, L. | 248/74.1; 248/220.41 |
| | | Clarke, Joseph | |
| | | Jackson, Kyle A. | |
| | | Zera, Robert A. | |
| U.S. Pat. No. 6,837,641 B2 | Jan. 4, 2005 | Paul, Christopher P. | 402/4 |
| U.S.-2009/0250366 A1 | Oct. 8, 2009 | Esfahani, Amir | 206/371 |
| U.S.-2012/0032043 | Feb. 9, 2012 | McGreevy, Sean C. | (2006.01)/248/205.3 |
| | | Thompson, Craig D. | |
| | | Qiblawi, Jameel R. | |
| | | Fu, Berlin | |
| | | Kun, Ho H. | |
| Foreign Patent Doc. No.: | | | |
| DE 4403439 A1 | | Eckel, Bernd | A45C 11/04 |
| PCT/PH2004/000002 A1 | Aug. 25, 2005 | Guevara, Isabel F. | |

### NON-PATENT LITERATURE

“Case Envy Business Card Holder 3-Ring Binder Accessory”, Paperhaus,
http://paperhaus.com/binderaccessories-c-200_{—}201_{—}233/case-envy-business-card-holder-3-ring-binder-accessory-fits-8-5×11-3-ring-binders-translucent-p-1206, (Apr. 27, 2010)
“Command™ Strips & Hooks—command.com”, 3M
http://www.command.com/wps/portal/3M/en_US/NACommand/?WT.mc_id=www.command.com&WT.ctod=18:44 (Sep. 10, 2013)

### BACKGROUND OF THE INVENTION

1. Field of the Invention

This application relates generally to devices for holding and storing various articles particularly with an adhesive backing.

2. Description of the Related Art

Originally smaller items were just left to rest on tables or other flat surfaces creating clutter, un-aesthetically pleasing environments, disorganization, and a drastic reduction in useable space. Wires would dangle from their respective devices or attachments. As more people use, own, and carry more and more smaller articles, some means is needed for properly storing various types of articles. The device would not be bound or limited to one dimension such as any horizontally flat surface like a table but has the option to be stored on another dimension such as a wall. As consumers lean toward sleek, futuristic, and clean looking products, the need for a device with the aforementioned characteristics to have the capability to be customized with graphics and to look sleek, slim, and unique is ever so needed. A single holding device with the ability to secure more than one article at once is also being sought by the public.

This problem has been partially solved by previous adhesive backed or fastener devices but these still had significant problems. Esfahni shows an adhesive pen holder with an elastic loop and an adhesive backing. Although this device has a graphics/screen printable body, I have found that this device is limited only to pen-like or smaller tubular articles. I have also found that the radius of the loop is fixed and is non-adjustable providing restriction to the types of articles that can be secured. The

Other devices have been proposed that are able to secure various articles. Servis's proposal includes a flexible back panel and a flexible front panel that attaches to a pocket with a releasable fastener in the back such as suction cups. I have found that this article holder cannot be attached to a wall in different positions, sideways, upside down, etc . . . Although it uses inexpensive material the device acts like a pants pocket with suction cups. It does not offer any aesthetically pleasing, sleek, neat, and appearance as an adhesive storing device. I have also found that the material is not suitable for any type of graphics printing. The suction cups are not reliable enough to properly stick to other solid surfaces such as drywall.

Command Brand creates different types of decorative hooks that can be attached to a solid surface utilizing 3M's stretchable adhesive patented technology. Each hook is made up of a plastic material either dear or another solid color. Although this device aims to save space by being able to secure different types of object on a solid surface such as a wall, the device is made from ordinary plastic and is subject to more wear and tear, faces a shorter life-span, and does not look aesthetically pleasing. I have found that the hook is molded into the body. Thus the distance from the body, gap and space the hook creates in order to house objects is restricted. The main body of the hook could have graphics or designs placed on it however, the article would be blocking it from view.

Several other types of article holders that can be attached to various types of surfaces have been proposed—for example, in Germany DR 4403439, U.S. 2004/0200040, U.S. 2005/0279648 A1, and U.S. Pat. No. 4,290,522 although they are inexpensive to manufacture, they show a very limited function for its holding mechanisms. I have found that the hooks or other means of securing the article are made of rigid material and demonstrates no elasticity or adjustability. As a result, they are mostly limited to securing eyeglasses only. Nevertheless, all article holders heretofore known suffer from a number of disadvantages:

a. Lack of aesthetics. The shape and manufacturing process of the mentioned devices comprise the sleeker, cleaner appearance as well as labeling and printability for custom designs, graphics, and art.
b. The restriction and limited capabilities of their securing mechanisms are limited to specific article leaving narrower options for the user.
c. Printing on plastic or synthetic fiber surfaces are often easily erased, thereby reducing its pristine appearance while increasing fading.
d. The reliance of a support structure such as a bedpost, bathroom mirror, or other suitable support structures.
e. The device's ability to secure the article at only a certain angle. For example Servis's Article Holder cannot be placed upside down or sideways.
f. Plastics and synthetic fiber materials durability, longevity, and resistance to wear and tear.
g. The ability to secure more than one article at the same time.

### SUMMARY

In accordance with one embodiment a various article holder comprises of a rigid body, clips, clip mounds, and an adhesive material on one of its sides.

### ADVANTAGES

Accordingly several advantages of one or more aspects are as follows: to provide a device that is not restricted to holding one item, that is not limited to one type, that offers flexibility to the user, relatively inexpensive, that can have an adjustable securing mechanism, that has a sleek, clean, and futuristic appearance aesthetically pleasing, that can be easily manufactured with graphics or screen printed designs, artistically focuses on the object and the holder, that is easy to clean, durable, maintain a pristine appearance, can be arranged in different angled and non-porous surfaces, and is a space saver. Other advantages of one or more aspects will be apparent from a consideration of the drawings and ensuing description.

### BRIEF DESCRIPTION OF THE DRAWINGS

FIG. 1 is a front elevation view of a first embodiment.

FIG. 2 is a front elevation view of a first embodiment positioned vertically.

FIG. 3 is a front elevation view of a first embodiment shown illustrating a generic logo.

FIG. 4. is an environmental view of a first embodiment attached to a solid surface illustrating a graphic.

FIG. 5. is an environmental, perspective view of a first embodiment illustrating various features thereof and attached to a solid surface.

FIG. 6 is a side elevation view of a first embodiment.

FIG. 7. is an elevation view in accordance with another embodiment.

FIG. 8. is an elevation view of a first embodiment.

FIG. 9 is an elevation view of a first embodiment taken from above.

FIG. 10 is an elevation view taken from above in accordance with another embodiment.

1. Reference Numerals

| | |
|---|---|
| 10. Body | 12. Clip Mound |
| 14. Clips | 16. Detent |
| 18. Adhesive | 20. Clip mound stops |
| 22. Face part of body opposite of adhesives | 24. Elastic pad |
| 26. Binder Holes | |

### DETAILED DESCRIPTION OF THE PREFERRED EMBODIMENTS

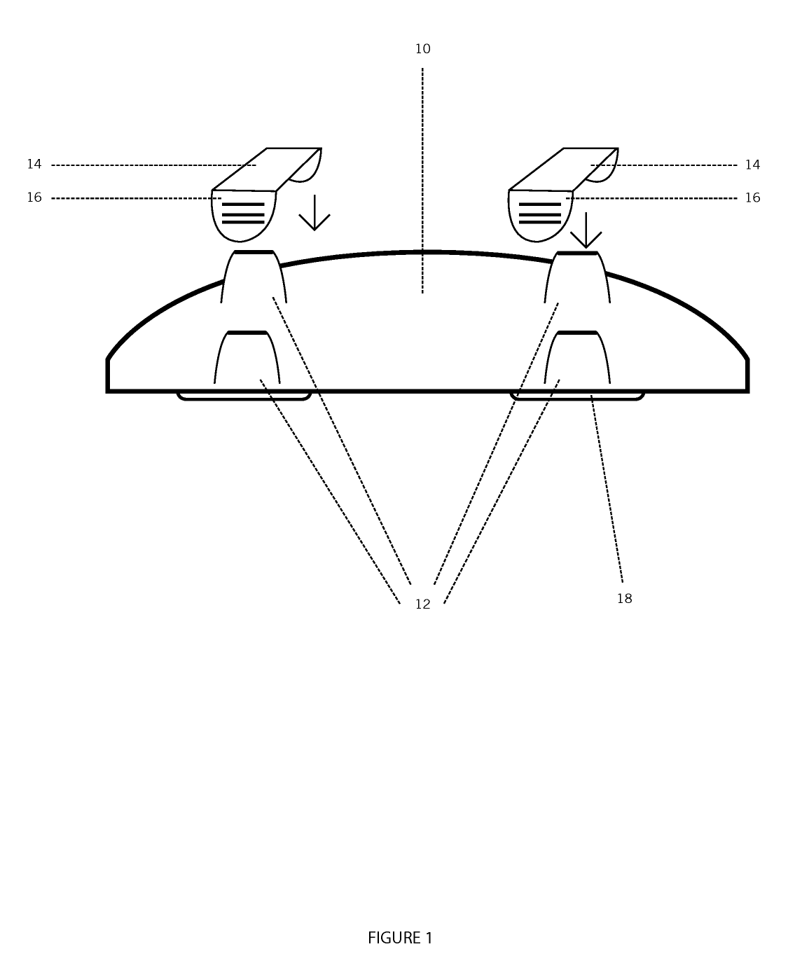

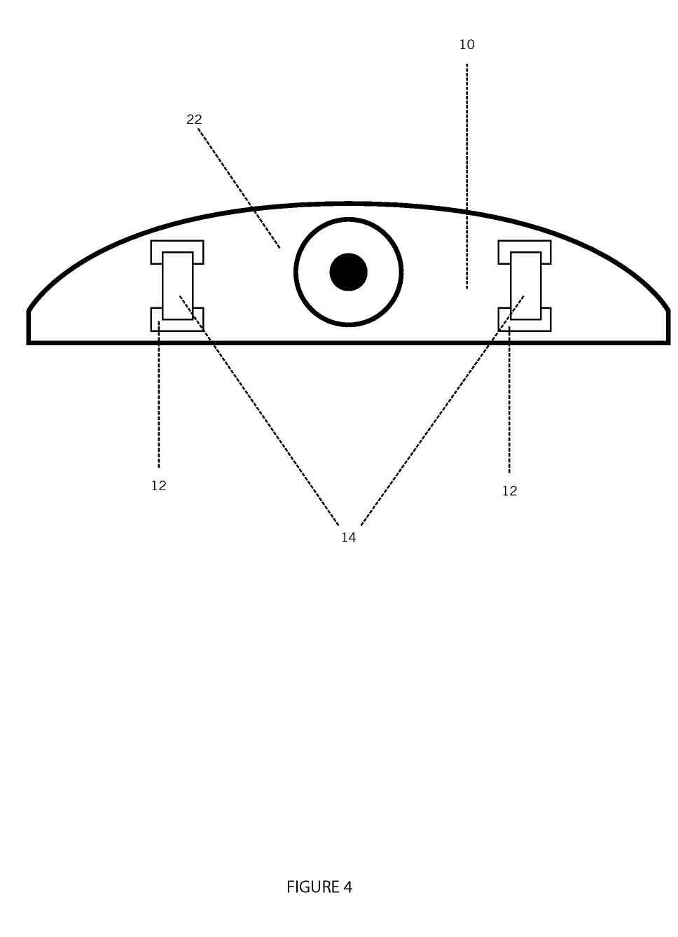

Referring now more specifically to FIGS. 1-6 and 8. The article holder has a rigid body 10 and I contemplate that it should be made of stainless steel, however it can consist of any rigid body that is solid, reliable, and offer a sleek appearance. In one embodiment four clip mounds 12 protrude from the main body 10. Clips 14 are two separate clips that are inserted inside the clip mounds 12 in this embodiment. Detents 16 along the clips 14 can be seen in one embodiment. The adhesives 18 on the backside of the holder is being shown.

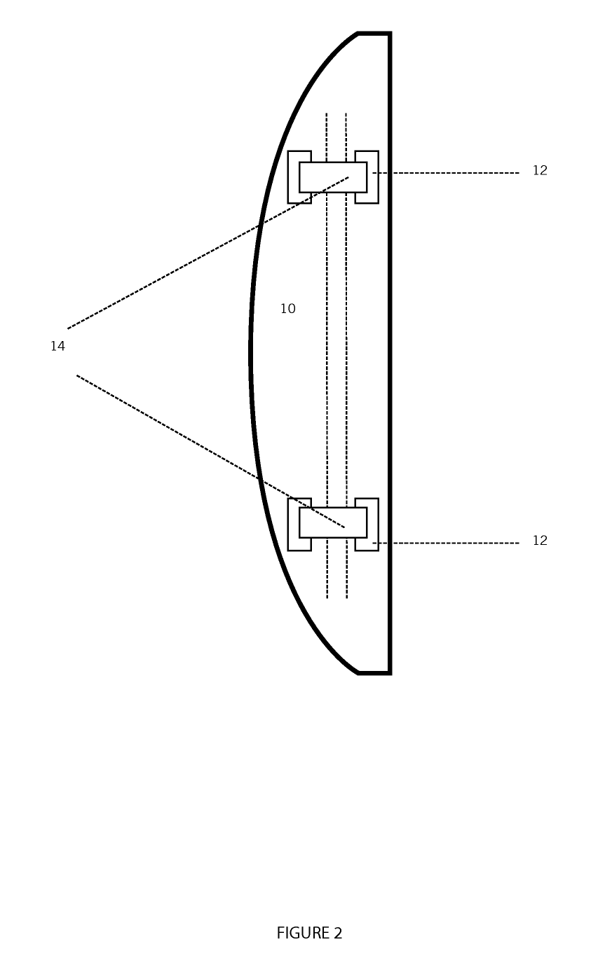

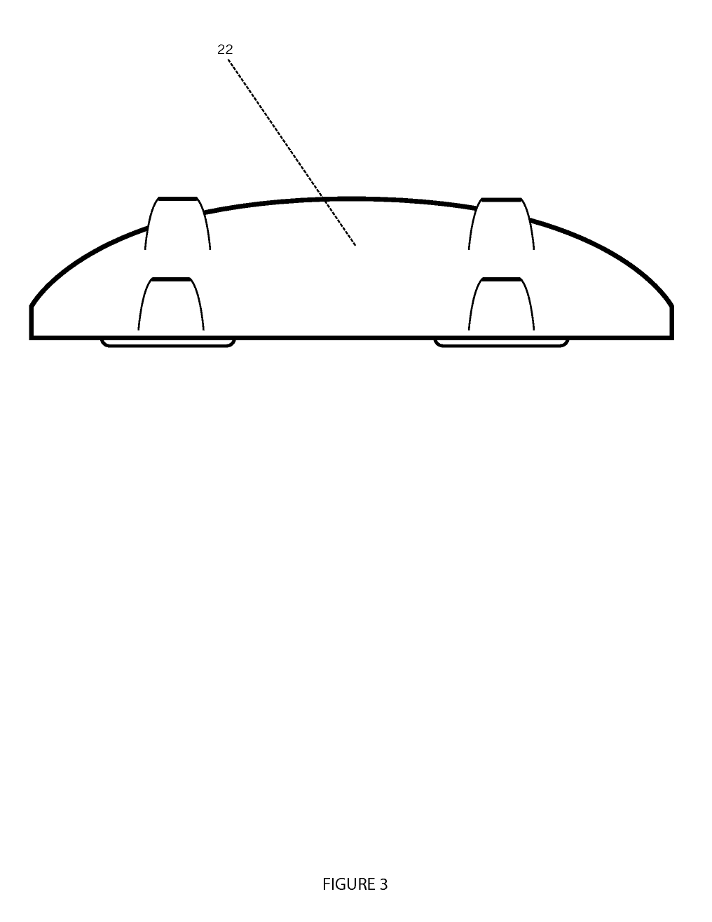

FIG. 2. shows the article holder body 10 in a vertical position while a writing utensil is secured by clips 14 are inserted inside clips mound 12. The front of the body 22 FIG. 3 opposite the sides of the adhesives shows a logo maybe printed on that portion. A graphic or art work placed on 22 the face of the body is shown in relation to clip mounds 12 and the clips 14. The body 10 is viewed from an elevation.

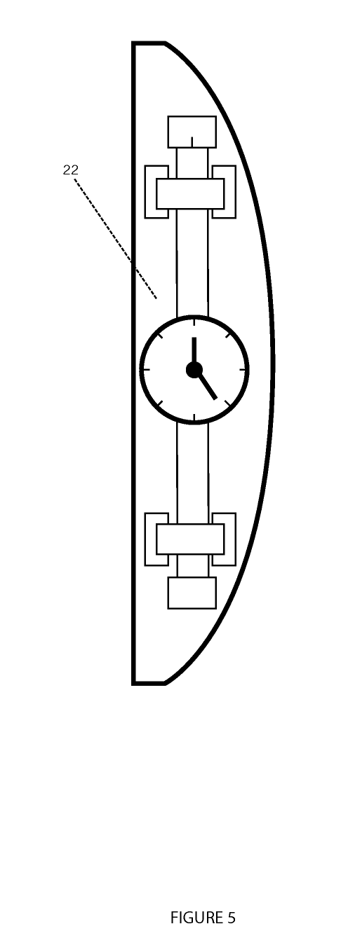

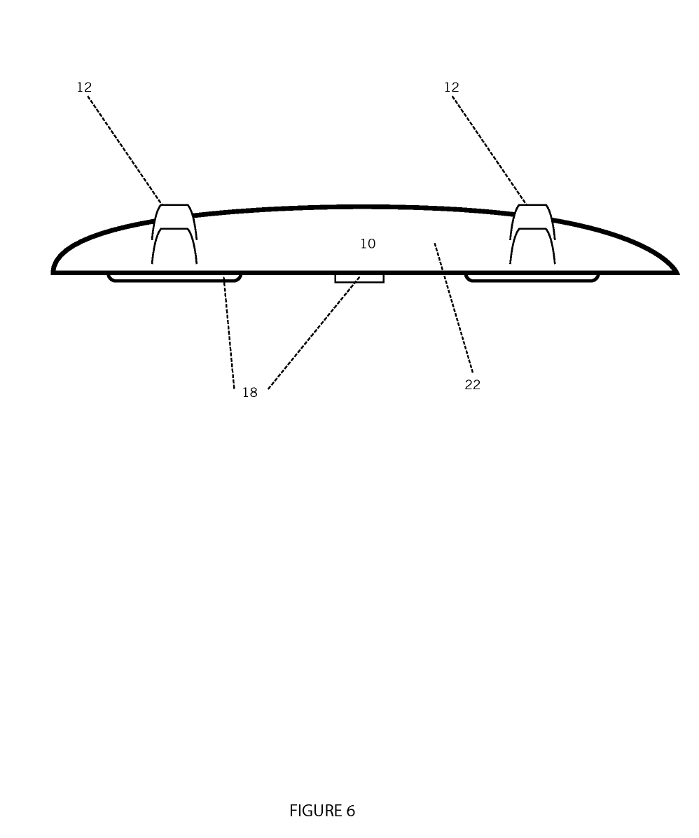

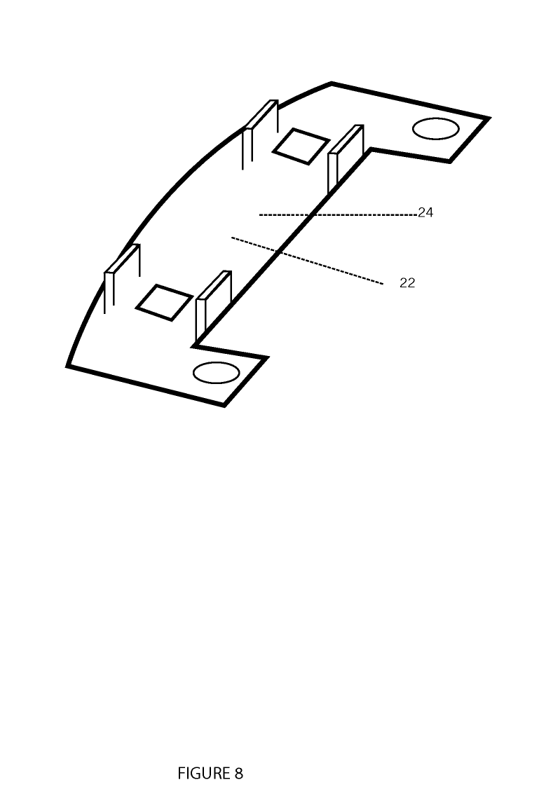

FIG. 5. Shows another view of the face part of the body 22 while a watch is being secured. FIG. 6 shows the body 10, the clip mounds 12, the adhesives 18, and the face of the body 22 from a side view. FIG. 8 shows another perspective of one embodiment.

A void is created between the clips 14 and the body 10 as it is locked up or down into clips mound 12. I contemplate that the clips 14 be made of a rigid material that has elasticity.

### 1. Operation—FIGS. 1, 9, 10

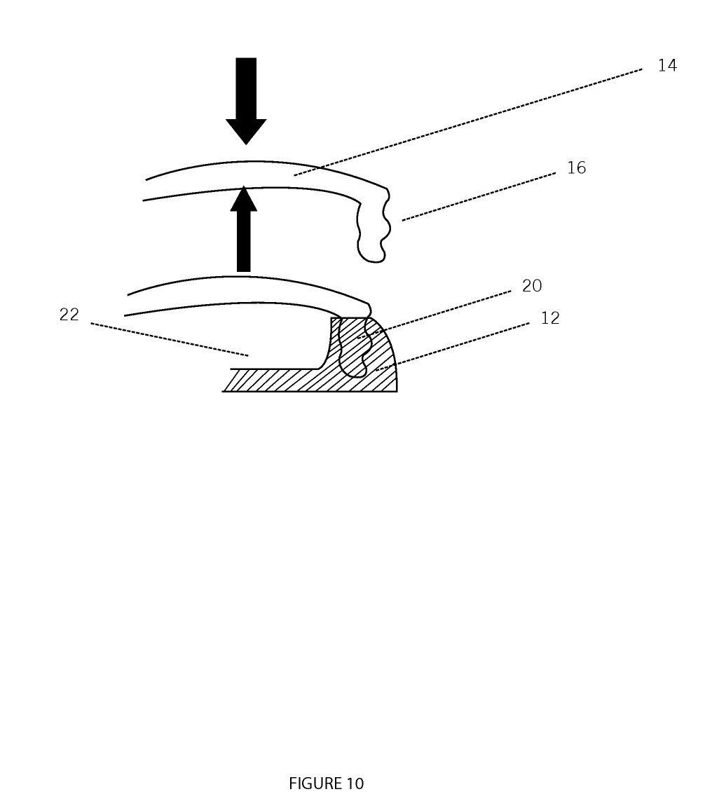

The manner of which the holder can secure various types of articles is due to several features. (FIGS. 1 and 10) The clips 14 will act as a securing mechanism that demonstrates rigidity and elastic characteristics. The clips 14 will have detents 16 or protrusions that allow it to be locked into several positions inside clips mound 12 which have stops inside 20. The article will rest upon the body 10 as the clips 14 provide resistance with just the right amount of force. With the clips 14 being locked into place inside clips mound 12, the user can slide the item that was previously placed inside the clips 14 in and out.

By pulling or pushing on the clips 14, the detents 16 and clips mound stops 20 would allow the user to appropriately increase or decrease the void between the clips 14 and the body 10. Thus, allowing more flexibility for the type of article to be secured. The clips 14 can also be removed by pulling on it past the stops 20 and pushed down as far as possible toward the body 10 for smaller items such as wires to be secured. The clips 14 are completely independent of one another as there are two separate clips mounds 12 allowing more than 1 item to be stored. In addition, the body 10 can have logos or graphics on it, thereby enhancing its aesthetics. I have contemplated that the body be shaped into a blade like shape as shown in this embodiment. But it can be on any shaped rigid body.

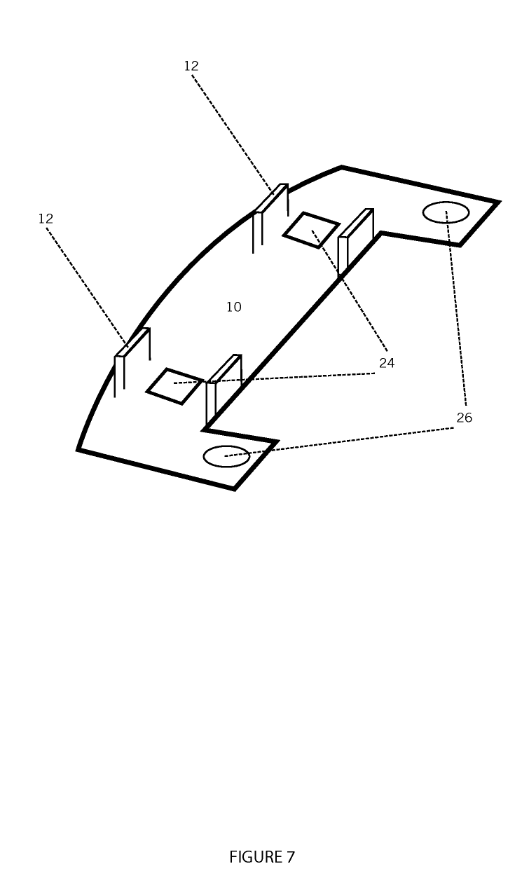

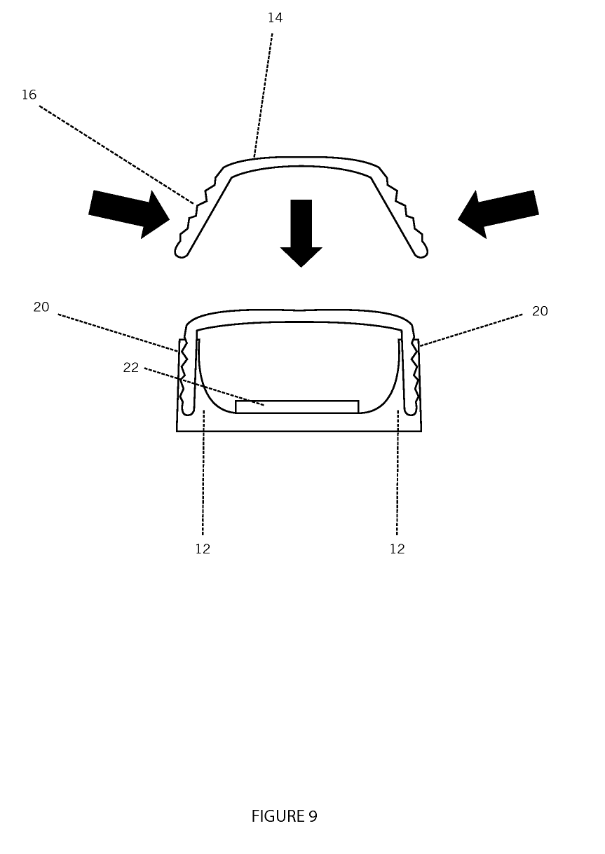

### 2. Alternative Embodiments FIGS. 7 and 9

There are various possibilities with regard to the relative disposition of securing the articles. FIG. 7 shows that the body 10 has an elastic pad 24 placed next to the clip mounds 11 and binder holes 26. The elastic pads 24 would allow the object to be pushed down slightly even if the clips were not made of an elastic material, thus offering more security. The hinder holes 26 would allow the device to be used as a pen holder on standard 3 ring binders.

FIG. 9. Shows the clips 14 extending slightly further out horizontally enabling it to be squeezed outward on clips mound 12 and squeezed inward to be moved up and down along the stops 20. Another alternative embodiment is the use of hooks and loops on a solid body to place or store an article

### 3. Advantages

From the description above, a number of advantages of some embodiments of my various article holder become evident:

a. As devices and articles get smaller and smaller for flexibility and advancement in technology the need for a storage device that can secure them will be sought after.
b. With the use of article holder common smaller articles that are normally misplaced can now have a resting/home spot.
c. The presence of an article holder that has adhesives will allow the user to be creative, dynamic, and unique in storing items in any room or flat surface
d. Jewelry and other common articles can be displayed in an artistic fashion similar to a painting.
e. A reduction in misplaced objects.
g. Eye glasses can now be stored at a closer proximity when it is needed the most.
h. More room on surfaces such as desks and night stands.
i. A prominent display for 3D TV glasses
j. improvement in ergonomics as the article holder can utilize any sold surface and placed on any dimension.
k. Flexibility for the user as a variety of items can be properly stored.

### 4. Conclusion, Ramifications, and Scope

Accordingly, the reader will see that the various article adhesive holder of the various embodiments can be used to store multiple and a variety of items easily and conveniently, can be removed just as easily without damage or hassle to the article, and can be locked into the same position if the same item is going to be placed back in without requiring any special adjustments. In addition, when an article needs to be secured the mechanisms can be adjusted accordingly to fit the need, without it being fixed or catering to just one type of article. Furthermore, the various article adhesive holder has the additional advantages that:
it permits the production in a variety of logo's, designs, advertisement without its durability and sleek appearance be compromised;
it easily permits immediate change in article storing ability;
it allows to be stored on multiple surfaces at any angles;
it changes the social perception on common articles;
it provides flexibility user friendliness:
it is dynamic to the user's demands.

Although the description above contains many specificities, these should not be construed as limiting the scope of the embodiments but as merely providing illustrations of some of several embodiments. For example, the body can have other shapes, such as circular, oval, trapezoidal, triangular, etc . . . the clips can have other shapes, the clip materials can be replaced by a fixed, molded hook, rubber, or any other solid or elastic material. The clip mounds can be added or reduced. The clips can go inside the clip mounds, along the side, or on the outer face.

Thus the scope of the embodiments should be determined by the appended claims and their legal equivalents, rather than by examples given.

1. An article holder of the type comprising a flat body the improvement wherein said article holder of having a plurality of mounds on one side, securing fastener that lock into position on said mounds, and an adhesive material on one side opposite the mounds

2. The article holder of claim 1 wherein said body of material is composed of Stainless Steel.

3. The article holder of claim 1 wherein said body is elongated and has a plurality of mounds attached or molded on one side of said body.

4. The article holder of claim 3 wherein said mounds contains stops or detents.

5. The article holder of claim 3 wherein exist a plurality of mounds.

6. The article holder of claim 1 wherein said body has securing fasteners are made of an elastic rigid material.

7. The article holder of claim 5 wherein said securing fastener have detents along its body

8. The article holder of claim 5 wherein said securing fastener are removable from the body.

9. The article holder of claim 1 wherein said securing fastener are made of an elastic rigid material

10. The article holder of claim 1 wherein said body is of a form that is conductive of arts or graphics printing.

11. The article holder of claim 1 wherein said body has adhesives on the opposite side of the mounds allowing attachment to various surfaces

12. A method of securing various articles, comprising;

13. (a) providing an article holder of the type comprising a flat body wherein said article holder of having a plurality of mounds on one side, securing mechanisms that lock into position on said mounds, and an adhesive material on one side opposite the mounds.

14. (b) providing securing fastener that hold the articles placed within the mechanisms

15. (c) pushing and pulling said securing fasteners thereby adjusting the void between the mechanisms and body allowing various types of articles to be secured accordingly.

16. (d) inserting an article into either side of the mounds and be placed under securing fastener

17. (e) whereby article holder's main body can be placed on any solid surface at any angle.

18. (f) whereby the article holder's securing fasters stop and lock along the mounds.
